(19) United States
(12) Patent Application Publication
(10) Pub. No.: US 2021/0084497 A1
(43) Pub. Date: Mar. 18, 2021

(54) CONTROL UNIT AND METHOD FOR THE TAMPER-PROOF CAPTURE OF INTEGRITY MONITORING DATA RELEVANT TO OPERATIONAL SAFETY

(71) Applicant: Siemens Aktiengesellschaft, Munich (DE)

(72) Inventor: Rainer Falk, Poing (DE)

(21) Appl. No.: 16/970,246

(22) PCT Filed: Dec. 11, 2018
(86) PCT No.: PCT/EP2018/084387

§ 371 Date: Aug. 14, 2020

(30) Foreign Application Priority Data
Feb. 20, 2018 (EP) 18157606.7

(51) Int. Cl. H04W 12/12; H04K 3/00; G07C 5/00

(52) U.S. Cl. CPC H04W 12/12; H04K 2203/36; G07C 5/008; H04K 3/22

(57) ABSTRACT

A control unit which includes at least one processor designed to carry out the following steps: —tamper-proof detection of operational safety-related integrity monitoring data of a system which is equipped with an operational safety-critical function and which is connected or can be connected to a communications network by radio transmission, the integrity monitoring data describing integrity monitoring of the system and external access to the radio transmission; and —tamper-proof recording and/or storing of the integrity monitoring data in order to evaluate same in the event of a use of the operational safety-related function is provided.

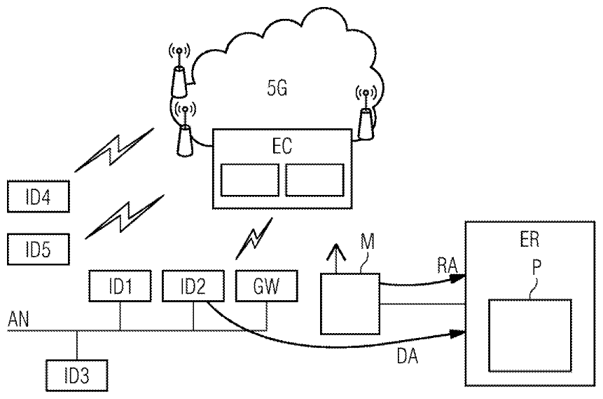

### CROSS-REFERENCE TO RELATED APPLICATIONS

This application claims priority to PCT Application No. PCT/EP2018/084387, having a filing date of Dec. 11, 2018, which is based off of European Patent Application No. 18157606.7, having a filing date of Feb. 20, 2018, the entire contents both of which are hereby incorporated by reference.

### FIELD OF TECHNOLOGY

The following relates to a control unit and a method for the tamper-proof capture of integrity monitoring data relevant to operational safety.

### BACKGROUND

There is a need to protect products, for example devices (for example control devices, Internet-of-Things (IoT) devices), device components or software components, from tampering and/or reverse engineering using IT security mechanisms. Cryptographic IT security mechanisms are already used, for example, in smart devices, for example in devices of the Internet of Things (IoT), of cyberphysical systems, of automation systems in energy technology or of production systems, of operating technology and of other installations.

Within the scope of the present description, the term “security” relates substantially to the security or protection, confidentiality and/or integrity of data and their transmission and also to security, confidentiality and/or integrity when accessing corresponding data. Authentication during data transmissions or during data access also belongs to the term “security”, as used within the scope of the present description. In this case, a module may be in the form of a hardware and/or functional unit which may be configured using software and/or firmware. The function may be performed, for example, by means of a processor and/or a storage unit for storing program instructions.

In the present description, tamper-proof goes beyond the term “security”. In this case, not only are the cryptographic or security methods mentioned used, but the data transmission is also reliably safeguarded against external attacks or unauthorized access.

Industrial devices, for example control devices, field devices, IoT devices or IoT gateways, use a plurality of cryptographic keys, for example in order to be authenticated, in order to protect the integrity of stored data and program code, in order to test and decrypt firmware updates and in order to protect the integrity and possibly the confidentiality of project-planning and configuration data. In order to transmit data, in particular control data, the devices mentioned may be equipped with a data interface which may be designed and configured to be wired and as a wireless interface, for example a WLAN, Bluetooth or NFC interface (NFC: Near Field Communication). The device can be connected to a network and can communicate with other devices with the aid of this data interface.

In this case, further wireless or radio-based transmission technologies can be used (for example Safety over WLAN, for example ProfiSafe, WiMax, Cloud Robotics, GSM, UMTS, LTE, 5G, vehicle-2-X communication for autonomous vehicles or autonomous driving, radio-based train protection ETCS). An item of position information (PVT: position, velocity, time) which is used for a control function of the device can also be received in a radio-based manner via a satellite navigation system (GPS, Galileo, Beidou, Glonass).

There is a need for reliable communication when wirelessly transmitting control data and additional data which are used for control. In this case, it must be assumed that the radio transmission can be temporarily disrupted or interrupted.

It is possible to use so-called blackbox recorders or juridical recorders in safety-critical systems or systems critical to operational safety (that is to say protection of the functionality of trains, aircraft, rail vehicles etc.) in order to capture control data during ongoing operation and store said data in a tamper-proof manner. The circumstances of an accident can thereby be clarified after an accident. These are also referred to as train event recorder, flight data recorder or generally event data recorder. In aircraft, it is possible to record communication in the cockpit (cockpit voice recorder).

A faulty transmission to a radio block center (RBC) can be recorded, inter alia. In this case, an error in the message sequence, inconsistent messages or a radio link error may be captured, for example. This relates predominantly to the checking of time stamps and the correct formatting of messages.

It is also possible to record data communication in a network (packet capturing). So-called intrusion detection systems (W)IDS can be used to detect attacks on a (radio) network.

In radio technology, it is possible to digitize a reception signal and to evaluate a section of the reception signal as a so-called radio snippet or snapshot.

Methods for checking the integrity of devices are known. For example, EP 17180526.0 has already proposed integrity monitoring in an automation system, in which a check is carried out in order to determine whether the integrity of the production machines was complied with during production of a product. EP 17188718.5, for example, has also already proposed a method for the cryptographically protected monitoring of at least one component of a device or of an installation, wherein a blockchain-based cryptographic monitoring function, in particular a watchdog (for devices, containers, virtual machines), is provided.

### SUMMARY

An aspect relates to methods and apparatuses or devices in comparison with the above-mentioned prior art, in particular in the context of safety-critical functions.

An aspect relates to a control unit comprising at least one processor which is configured to carry out the following steps:
tamper-proof capturing of integrity monitoring data which are relevant to operational safety and relate to a system which is equipped with a function critical to operational safety and is connected or can be connected to a communication network by radio transmission, wherein the integrity monitoring data describe integrity monitoring of the system and/or external unauthorized access to the radio transmission, and
tamper-proof recording and/or storing of the integrity monitoring data for the purpose of evaluating the latter if the function relevant to operational safety is used.

A system equipped with a function critical to operational safety may be a device, an automation system/installation, a vehicle etc. The integrity monitoring is carried out at the runtime of the system.

The recording can also comprise logging in a so-called log file.

The function relevant to operational safety may be an accident report or emission of an emergency/alarm/warning signal/message. Functions critical to operational safety are implemented, in particular in the case of autonomous driving and cloud robotics, on IT-based systems using radio transmission (for example 5G cloud robotics). In this case, it is possible that intentional tampering with a device or the radio transmission was present during an accident and has caused or influenced the accident.

In order to be able to clarify, in the event of an accident, whether a disrupted or tampered radio transmission or device tampering originally resulted in the accident or was indirectly involved, a corresponding item of information which is available in a tamper-proof form is required.

One embodiment of the present invention provides for the processor to also be configured to output the recorded and/or stored integrity monitoring data in order to initiate evaluation of the latter on the basis of a received item of alarm and/or warning information which has been emitted on account of the safety-critical function being performed.

Integrity monitoring data may be recorded and/or stored during operation of the system. The integrity monitoring data may also comprise system control commands.

One embodiment of the present invention provides for the integrity monitoring data to also describe at least one property of the radio signal of the radio transmission and/or a digitized section (snippet or snapshot) of the radio signal.

One embodiment of the present invention provides for the recording and/or storing of the integrity monitoring data to have been or to be rendered tamper-proof by means of a cryptographic checksum.

One embodiment of the present invention provides for the recording and/or storing of the integrity monitoring data to be able to be or to be rendered tamper-proof by means of an attestation (time stamp, counter value).

One embodiment of the present invention provides for the control unit to be in the form of an application locally arranged in the system or in the form of a cloud and/or server service arranged outside the system.

For the tamper-proof recording and/or storing of the integrity monitoring data, one embodiment of the present invention provides for the latter to be written or to be able to be written to a cryptographically secure log file.

For the tamper-proof capture of the integrity monitoring data, one embodiment of the present invention provides for the latter to be set as a transaction in a blockchain data structure.

A blockchain is generally understood as meaning a database, the integrity of which (protection against subsequent tampering) is protected by storing the one-way function value, also called hash value, of the preceding data record or block or element in the in each case subsequent data record or block or element, that is to say by means of cryptographic concatenation. A transaction data record protected in the blockchain generally comprises program code in which conditions can be defined at the creation time and can be evaluated at its runtime, with the result that particular transactions of a particular amount (of money) can or cannot be carried out at one or more particular receivers. The transaction can be carried out with the aid of the transaction data record.

A further aspect relates to a method comprising the following steps:
tamper-proof capturing of integrity monitoring data which are relevant to operational safety and relate to a system which is equipped with a function critical to operational safety and is connected to a communication network by radio transmission, wherein the integrity monitoring data describe integrity monitoring of the system and/or external unauthorized access to the radio transmission, and
tamper-proof recording (logging) and/or storing of the integrity monitoring data for the purpose of evaluating the latter if the function relevant to operational safety is used.

A computer program (product) (non-transitory computer readable storage medium having instructions, which when executed by a processor, perform actions) comprising program code which can be executed by at least one processor and causes the at least one processor to carry out the method according to the present invention and its embodiments is also. The computer program can run on a device of the type mentioned above or can be stored as a computer program product on a computer-readable medium.

A variant of the computer program (product) with program instructions for configuring a creation device, for example a 3-D printer, may additionally be a computer system or a production machine suitable for creating processors and/or devices.

The method and computer program (products) may be designed according to the developments/embodiments of the above-mentioned device and its developments/embodiments.

### BRIEF DESCRIPTION OF THE DRAWINGS

Some of the embodiments will be described in detail, with reference to the following figures, wherein like designations denote like members, wherein:

The FIGURE schematically shows an environment in which a system critical to operational safety is used.

### DETAILED DESCRIPTION

A system equipped with a function critical to operational safety may be a device, an automation system/installation, a vehicle etc. Functions critical to operational safety are implemented, in particular in the case of autonomous driving and cloud robotics, on IT-based systems using radio transmission (for example 5G cloud robotics).

For reliable radio transmission in the broader sense, it is not only necessary to comply with methods which are robust with respect to disruptions and in which QoS (Quality of Service) parameters are caused. It is also necessary to detect disruptions and to be able to react to the latter. Conventional intrusion detection systems (IDS) and integrity monitoring are generally not sufficient.

The FIGURE shows devices ID1 to ID5 which are relevant to operational safety. They may be connected to an automation network AN using a gateway GW. They may also be connected to a cloud EC via a radio transmission 5G. An item of security integrity monitoring information (integrity monitoring data) which captured by means of a monitoring unit or device M by radio transmission and, concomitantly integrated in an event data recorder ER, recorded and/or stored in the control unit according to the embedment of the present invention in a tamper-proof manner. In the event of an accident, this makes it possible to detect a device which has been tampered with, a data transmission which has been tampered with, and disruption of a radio transmission. The captured security integrity information can comprise the following:
a device security health check, that is to say the checking of the integrity of program code and/or configuration data at the runtime or during operation of the device,
status of the host/network/wireless intrusion detection system (IDS),
radio range: information relating to the signal quality (signal strength, bit error rate, channel estimation, determined “jamming” information, that is to say derived information relating to interferers, type of interferer),
raw radio snippets (digitized baseband signal) or a continuous digitized baseband signal.

This information or data relating to security integrity monitoring is recorded in an event data recorder in a tamper-proof manner, with the result that said information can be evaluated in the event of an accident. The event data recorder can be locally implemented as a special hardware appliance, that is to say a combination of hardware, possibly firmware and software, and has a processor P. However, it may also be implemented as a cloud service in a cloud EC, for example a central cloud or a so-called edge cloud.

The integrity monitoring data are made available to the event data recorder in a manner protected by a cryptographic checksum. This may be, for example, an attestation (for example a device attests that its device health check provides the status “OK”). The attestation includes a time stamp or a counter value, with the result that the up-to-dateness can be verified. The captured information may be, in particular, a secure log or may be set as a transaction in a blockchain data structure or a distributed ledger data structure.

According to the embodiment of the present invention, device integrity attestations DA and radio integrity measurement data RA are captured and are captured and/or recorded and/or stored as part of the integrity monitoring data in an event data recorder in order to be available for possibly required evaluation. The event data recorder may also be in the form of an application (app) in an edge cloud. Various other implementations are conceivable. For example, it is possible to use a conventional cloud instead of an edge cloud or the integrity monitoring data can be locally controlled and recorded in a control network which is physically or logically separated and is not illustrated in the FIGURE.

Although the present invention has been described and illustrated more specifically in detail by means of the exemplary embodiment, the present invention is not restricted by the disclosed examples and other variations can be derived therefrom by a person skilled in the art without departing from the scope of protection of the present invention.

The processes or method sequences described above can be implemented on the basis of instructions which are available on computer-readable storage media or in volatile computer memories (referred to collectively below as computer-readable memories). Computer-readable memories are, for example, volatile memories such as caches, buffers or RAM and non-volatile memories such as removable data storage media, hard disks, etc.

The functions or steps described above may be present in this case in the form of at least one instruction set in/on a computer-readable memory. In this case, the functions or steps are not tied to a particular instruction set or to a particular form of instruction sets or to a particular storage medium or to a particular processor or to particular execution schemes and may be executed by means of software, firmware, microcode, hardware, processors, integrated circuits etc. operating alone or in any desired combination. In this case, a wide variety of processing strategies can be used, for example serial processing by means of an individual processor or multiprocessing or multitasking or parallel processing etc.

The instructions may be stored in local memories, but it is also possible to store the instructions on a remote system and to access them via a network.

The term “processor”, “central signal processing”, “control unit” or “data evaluation means”, as used here, comprises processing means in the broadest sense, that is to say, for example, servers, universal processors, graphics processors, digital signal processors, application-specific integrated circuits (ASICs), programmable logic circuits such as FPGAs, discrete analog or digital circuits and any desired combinations thereof, including all other processing means known to a person skilled in the art or developed in future. In this case, processors may consist of one or more apparatuses or devices or units. If a processor consists of a plurality of apparatuses, they can be designed or configured for parallel or sequential processing or execution of instructions.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed:

1. A control unit comprising at least one processor which is configured to carry out the following steps:
tamper-proof capturing of integrity monitoring data which are relevant to operational safety and relate to a system which is equipped with a function critical to operational safety and is connected connected to a communication network by radio transmission, wherein the integrity monitoring data describe integrity monitoring of the system and external unauthorized access to the radio transmission, and
tamper-proof recording and/or storing of the integrity monitoring data for evaluating the latter if a function relevant to operational safety is used.

2. The control unit as claimed in claim 1, wherein the processor is also configured to output the recorded and/or stored integrity monitoring data in order to initiate evaluation of the latter on a basis of a received item of alarm and/or warning information which has been emitted on account of the safety-critical function being performed.

3. The control unit as claimed in claim 1, wherein the integrity monitoring data are recorded and/or stored during operation of the system.

4. The control unit as claimed in claim 1, wherein the integrity monitoring data also describe at least one property of the radio signal of the radio transmission and/or a digitized section of the radio signal.

5. The control unit as claimed in claim 1, wherein the integrity monitoring data also comprise system control commands.

6. The control unit as claimed in claim 1, wherein the recording and/or storing of the integrity monitoring data is/are rendered tamper-proof by means of a cryptographic checksum.

7. The control unit as claimed in claim 1, wherein the recording and/or storing of the integrity monitoring data can be rendered tamper-proof by means of an attestation.

8. The control unit as claimed in claim 1, wherein the control unit is an application locally arranged in the system or a cloud and/or server service arranged outside the system.

9. The control unit as claimed in claim 1, wherein for the tamper-proof capture of the integrity monitoring data, the latter are set as a transaction in a blockchain data structure.

10. The control unit as claimed in claim 1, wherein the tamper-proof recording and/or storing of the integrity monitoring data, the latter are written to a cryptographically secure log file.

11. A method comprising:
tamper-proof capturing of integrity monitoring data which are relevant to operational safety and relate to a system which is equipped with a function critical to operational safety and has been or is connected to a communication network by radio transmission, wherein the integrity monitoring data describe integrity monitoring of the system and external unauthorized access to the radio transmission, and
tamper-proof recording and/or storing of the integrity monitoring data for the purpose of evaluating the latter if the function relevant to operational safety is used.

12. The method as claimed in claim 11, wherein the recorded and/or stored integrity monitoring data are output in order to initiate evaluation of the latter on a basis of a received item of alarm and/or warning information which has been emitted on account of the safety-critical function being performed.

13. The method as claimed in one claim 11, wherein the integrity monitoring data are recorded and/or stored during operation of the system.

14. The method as claimed in claim 11, wherein the integrity monitoring data also describe at least one property of the radio signal of the radio transmission and/or a digitized section of the radio signal.

15. The method as claimed in claim 11, wherein the integrity monitoring data also comprise system control commands.

16. The method as claimed in claim 11, wherein the recording and/or storing of the integrity monitoring data has/have been or is/are rendered tamper-proof by means of a cryptographic checksum.

17. The method as claimed in claim 11, wherein the recording and/or storing of the integrity monitoring data has/have been or is/are rendered tamper-proof by means of an attestation.

18. The method as claimed in claim 11, wherein the control unit is an application locally arranged in the system or a cloud and/or server service arranged outside the system.

19. The method as claimed in claim 11, wherein the tamper-proof capture of the integrity monitoring data, the latter are set as a transaction in a blockchain data structure.

20. The method as claimed in claim 11, wherein the tamper-proof recording and/or storing of the integrity monitoring data, the latter are written to a cryptographically secure log file.

21. A computer program comprising program code which can be executed by at least one processor and causes the at least one processor to carry out the method as claimed in claim 11.
